(19) United States
(12) Patent Application Publication
(10) Pub. No.: US 2022/0010584 A1
(43) Pub. Date: Jan. 13, 2022

(54) HANDS-FREE DOOR OPENING SYSTEMS AND METHODS

(71) Applicant: iSee Store Innovations, L.L.C., St. Louis, MO (US)

(72) Inventor: Steven Allen Brenner, Richmond Heights, MO (US)

(73) Assignee: iSee Store Innovations, L.L.C., St. Louis, MO (US)

(21) Appl. No.: 17/068,006

(22) Filed: Oct. 12, 2020

Related U.S. Application Data
(63) Continuation-in-part of application No. 16/926,808, filed on Jul. 13, 2020.

(51) Int. Cl. E05B 1/00

(52) U.S. Cl. CPC E05B 1/0015; E05Y 2600/10; E05Y 2900/132; E05Y 2600/60; E05Y 2600/52

(57) ABSTRACT

A door opening system and method include a mounting base, an engagement protuberance extending from the mounting base, a first securing assembly having a first suction cup coupled to the mounting base, and a second securing assembly having a second suction cup coupled to the mounting base. The first suction cup and the second suction cup are configured to secure the door opening system to a door of a structure. The engagement protuberance is configured to be engaged in a hands-free manner to open the door.

### RELATED APPLICATIONS

This application is a continuation-in-part of U.S. patent application Ser. No. 16/926,808 entitled “Hands-Free Door Opening Systems and Methods,” filed Jul. 13, 2020, which is hereby incorporated by reference in its entirety.

### FIELD OF EMBODIMENTS OF THE DISCLOSURE

Embodiments of the present disclosure generally relate to door opening systems and methods, and more particularly to hands-free door opening systems and methods.

### BACKGROUND OF THE DISCLOSURE

Various structures include doors that are configured to be opened and closed. A door may be opened to expose an interior compartment of a structure. For example, a refrigerated compartment includes a glass door. Refrigerated compartments may be used in grocery stores, convenience stores, and/or the like to store and display various items for sale, such as beverages, food items, and/or the like. The glass door of a refrigerated compartment typically includes a handle that is configured to be grasped by a hand of an individual. That is, the individual uses a hand to grasp the handle to pivot the door into an open position.

However, various pathogens, such as germs, bacteria, viruses, and the like may be transferred from individuals' hands to the handle. Such pathogens may then be transferred to other individuals who also grasp the handle.

### SUMMARY OF THE DISCLOSURE

A need exists for a system and a method for opening a door of a structure that reduce a risk of spreading pathogens to individuals. Further, a need exists for a hands-free system and method for opening a door of a structure.

With those needs in mind, certain embodiments of the present disclosure provide a door opening system including a mounting base, an engagement protuberance extending from the mounting base, a first securing assembly having a first suction cup coupled to the mounting base, and a second securing assembly having a second suction cup coupled to the mounting base. The first suction cup and the second suction cup are configured to secure the door opening system to a door of a structure. The engagement protuberance is configured to be engaged in a hands-free manner to open the door.

In at least one embodiment, the first securing assembly further includes a first suction securing nut coupled to the first suction cup. At least a portion of the engagement protuberance is secured between the first suction cup and the first suction securing nut. The second securing assembly further includes a second suction securing nut coupled to the second suction cup.

In at least one embodiment, the mounting base includes a first end connected to a second end by an intermediate extension. The first securing assembly is coupled to the first end. The second securing assembly is coupled to the second end. In at least one embodiment, the first securing assembly is separated from the second securing assembly a distance that is at least twice a diameter of one or both of the first securing assembly or the second securing assembly.

In at least one embodiment, the first securing assembly is longitudinally aligned with the second securing assembly along a longitudinal axis of the mounting base.

In at least one embodiment, the mounting base includes a lip that is configured to abut against the door of the structure. The lip may extend around at least a portion of a perimeter of the mounting base.

The door opening system may also include a decal that is configured to be secured to a portion of the door opening system. The decal may include indicia that indicate instructions for opening the door, via the engagement protuberance, in the hands-free manner.

The engagement protuberance is distinct from a handle of the door. As an example, the engagement protuberance includes a mounting base, and a cuff extending outwardly from the mounting base away from the suction cup. As a further example, the mounting base includes a wall that is configured to abut against the first suction cup. A channel is formed through the wall. The channel is configured to receive a stem of the first suction cup that passes through the channel and is engaged by a first suction securing nut. As a further example, the cuff includes an arch outwardly extending from a wall of the mounting base, and a fin extending from the arch. The fin may include lateral edges connected by a main body that includes a lower portion connected to an upper portion. The main body may extend further outwardly at the upper portion than the lower portion. The fin may upwardly and outwardly curve from the arch.

Certain embodiments of the present disclosure provide a door opening method including coupling a first securing assembly having a first suction cup to a mounting base having an engagement protuberance extending therefrom, coupling a second securing assembly having a second suction cup to the mounting base, and securing (by the first suction cup and the second suction cup) the door opening system to a door of a structure. The engagement protuberance is configured to be engaged in a hands-free manner to open the door.

In at least one embodiment, the door opening method further includes abutting a lip of the mounting base against the door of the structure.

### BRIEF DESCRIPTION OF THE DRAWINGS

FIG. 1 illustrates a schematic block diagram of a door opening system configured to secure to a door of a structure, according to an embodiment of the present disclosure.

FIG. 2 illustrates a perspective front view of the door opening system secured to the door of the structure, according to an embodiment of the present disclosure.

FIG. 3 illustrates a perspective exploded view of the door opening system, according to an embodiment of the present disclosure.

FIG. 4 illustrates a front view of the door opening system of FIG. 3.

FIG. 5 illustrates a lateral view of the door opening system of FIG. 3.

FIG. 6 illustrates a bottom view of the door opening system of FIG. 3.

FIG. 7 illustrates a rear view of the door opening system of FIG. 3.

FIG. 8 illustrates a perspective bottom view of the door opening system of FIG. 3.

FIG. 9 illustrates a perspective view of a forearm engaging a cuff of the door opening system, according to an embodiment of the present disclosure.

FIG. 10 illustrates a perspective lateral view of a door opening system, according to an embodiment of the present disclosure.

FIG. 11 illustrates a front view of the door opening system of FIG. 10.

FIG. 12 illustrates a perspective exploded view of the door opening system of FIG. 10.

FIG. 13 illustrates a perspective front view of the door opening system of FIG. 10 secured to the door of the structure, according to an embodiment of the present disclosure.

FIG. 14 illustrates a perspective view of a forearm engaging a hook of the door opening system, according to an embodiment of the present disclosure.

FIG. 15 illustrates a front view of the door opening system of FIG. 10 secured to the door of the structure.

FIG. 16 illustrates a perspective view of a foot engaging the hook of the door opening system, according to an embodiment of the present disclosure.

FIG. 17 illustrates a perspective exploded view of a securing assembly, according to an embodiment of the present disclosure.

FIG. 18 illustrates a top view of a suction cup, according to an embodiment of the present disclosure.

FIG. 19 illustrates a lateral view of the suction cup.

FIG. 20 illustrates a perspective top view of the suction cup.

FIG. 21 illustrates a cross-sectional view of the suction cup through line 21-21 of FIG. 18.

FIG. 22 illustrates a bottom view of the suction cup.

FIG. 23 illustrates a lateral view of a locking ring, according to an embodiment of the present disclosure.

FIG. 24 illustrates a top view of the locking ring.

FIG. 25 illustrates a perspective top lateral view of the locking ring.

FIG. 26 illustrates a top view of a suction securing nut, according to an embodiment of the present disclosure.

FIG. 27 illustrates a lateral view of the suction securing nut.

FIG. 28 illustrates a bottom view of the suction securing nut.

FIG. 29 illustrates a perspective top view of the suction securing nut.

FIG. 30 illustrates a cross-sectional view of the suction securing nut through line 30-30 of FIG. 26.

FIG. 31 illustrates a top view of the securing assembly.

FIG. 32 illustrates a lateral view of the securing assembly.

FIG. 33 illustrates a bottom view of the securing assembly.

FIG. 34 illustrates a perspective view of the securing assembly secured to a structure, according to an embodiment of the present disclosure.

FIG. 35 illustrates a perspective top view of a stem of a suction cup, according to an embodiment of the present disclosure.

FIG. 36 illustrates a perspective view of a suction cup, according to an embodiment of the present disclosure.

FIG. 37 illustrates a top view of a suction cup, according to an embodiment of the present disclosure.

FIG. 38 illustrates a top view of a keying member of a suction cup, according to an embodiment of the present disclosure.

FIG. 39 illustrates a flow chart of a hands-free door opening method, according to an embodiment of the present disclosure.

FIG. 40 illustrates a perspective front view of a door opening system, according to an embodiment of the present disclosure.

FIG. 41 illustrates a front view of the door opening system of FIG. 40.

FIG. 42 illustrates a lateral view of the door opening system of FIG. 40.

FIG. 43 illustrates a bottom view of the door opening system of FIG. 40.

FIG. 44 illustrates a rear view of the door opening system of FIG. 40.

FIG. 45 illustrates a top view of the door opening system of FIG. 40.

FIG. 46 illustrates a perspective front view of the door opening system secured to a door of a structure, according to an embodiment of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and proceeded with the word “a” or “an” should be understood as not excluding plural of the elements or steps, unless such exclusion is explicitly stated. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Certain embodiments of the present disclosure provide a door opening system that includes a securing assembly having an engagement protuberance coupled to a suction cup. The suction cup is configured to secure door opening system to a surface of a door of a structure. The engagement protuberance is configured to be engaged in a hands-free manner to open the door.

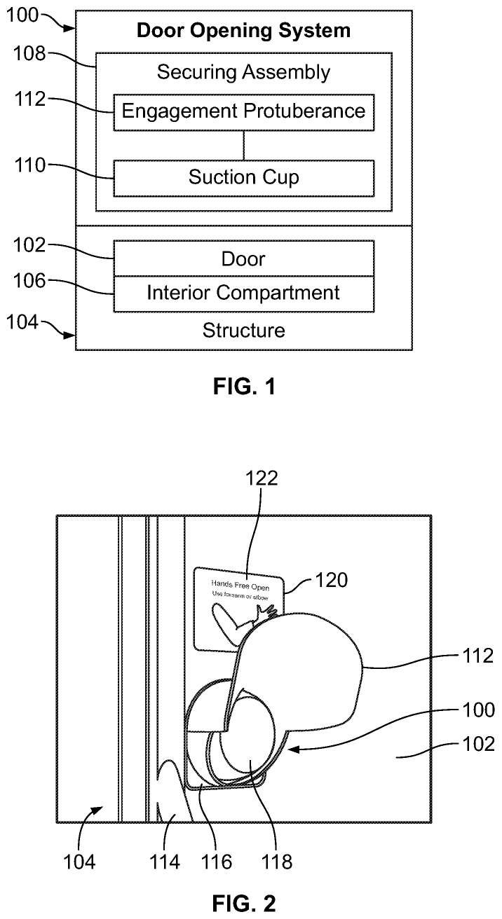

FIG. 1 illustrates a schematic block diagram of a door opening system 100 configured to secure to a door 102 of a structure 104, according to an embodiment of the present disclosure. The structure 104 includes an interior compartment 106 that is covered by the door 102 in a closed position. The door 102 is configured to be moved to an open position to expose the interior compartment 106. The door opening system 100 is configured to be engaged by an individual in a hands-free manner to open the door 102.

In at least one embodiment, the structure 104 is a refrigerated compartment that is configured to retain beverages, food items, and/or the like. As another example, the structure 104 can be a room or building, such as a residence or commercial establishment. As another example, the structure 104 can be a vehicle. In short, the structure 104 can be any component having a door that is configured to be opened and closed.

The door opening system 100 includes a securing assembly 108 that is configured to secure to the door 102. The securing assembly 108 includes a suction cup 110 that is configured to secure to a surface of the door 102. An engagement protuberance 112 is coupled to the suction cup 110. The engagement protuberance 112 is configured to be engaged by an individual in a hands-free manner to open the door 102 of the structure 104. The engagement protuberance 112 is not a standard handle that is configured to be grasped by a hand. Instead, the engagement protuberance 112 is configured to be engaged by a forearm, elbow, wrist, foot, or the like to open the door 102.

In at least one embodiment, the engagement protuberance 112 includes a cuff that is configured to be engaged by a forearm, wrist, or elbow of an individual to open the door 102 in a hands-free manner. In at least one other embodiment, the engagement protuberance 112 includes a hook that is configured to be engaged by a forearm, elbow, wrist, or foot of an individual to open the door 102 in a hands-free manner. As another example, the engagement protuberance 112 includes a fin, collar, or the like that is configured to be engaged by a forearm, elbow, wrist, foot, or leg of an individual to open the door 102 in a hands-free manner.

Embodiments of the present disclosure provide door opening systems 100 that are robust, user-friendly, and easy to install, such as by securing the suction cup 110 to the door 102. The engagement protuberance 112 is ergonomically configured to be engaged by a forearm, elbow, wrist, and/or foot.

The securing assembly 108, including the engagement protuberance 112 and the suction cup 110, can be formed of plastic. For example, the securing assembly 108 can be formed of polycarbonate. In at least one other embodiment, the engagement protuberance 112 can be at least partially formed of metal.

FIG. 2 illustrates a perspective front view of the door opening system 100 secured to the door 102 of the structure 104, according to an embodiment of the present disclosure. The structure 104 may include a handle 114 that is configured to be grasped by a hand. The door opening system 100 is separate and distinct from the handle 114. That is, the door opening system 100 is not the handle 114.

Referring to FIGS. 1 and 2, the door opening system 100 includes the engagement protuberance 112 coupled to the suction cup 110. In at least one embodiment, the engagement protuberance 112 includes a mounting base 116 secured between the suction cup 110 and a suction securing nut 118.

The door opening system 100 may also include a decal 120 that is configured to be secured to the door 102, such as through an adhesive. The decal 120 includes indicia 122, such as text, graphics, and/or the like, that indicate instructions for opening the door 102, via the engagement protuberance 112, in a hands-free manner.

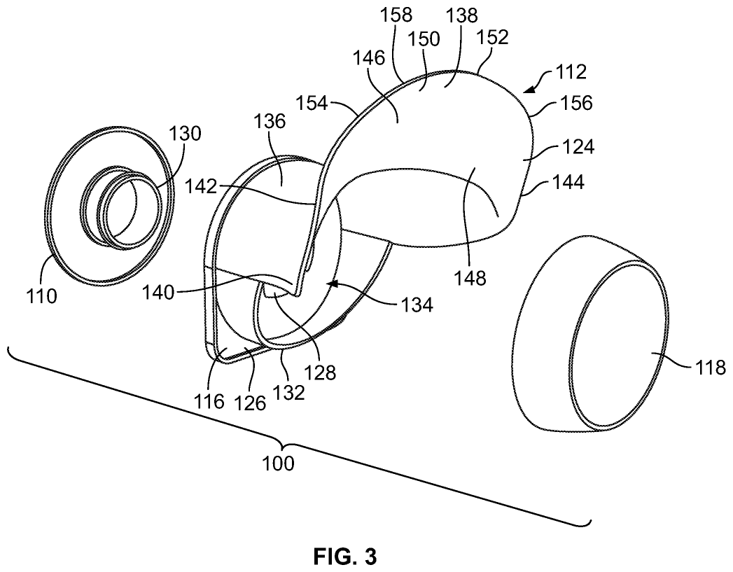

FIG. 3 illustrates a perspective exploded view of the door opening system 100, according to an embodiment of the present disclosure. The door opening system 100 includes the suction cup 110 coupled to the engagement protuberance 112 and the suction securing nut 118. At least a portion of the mounting base 116 is configured to be secured between the suction cup 110 and the suction securing nut 118.

The engagement protuberance 112 includes the mounting base 116 and a cuff 124 extending outwardly from the mounting base 116 away from the suction cup 110. The mounting base 116 includes a wall 126, such as a flat wall, that is configured to abut against the suction cup 110. A channel 128 is formed through the wall 126. The channel 128 is configured to receive a stem 130 of the suction cup 110. The stem 130 passes through the channel 128 and is engaged by the suction securing nut 118, which secures the engagement protuberance 112 to the suction cup 110.

Alternatively, the engagement protuberance 112 may secure to the suction cup 110 without the suction securing nut 118. For example, engagement protuberance 112 may be secured to the suction cup 110 through an adhesive, fasteners, latches, and/or the like. As another example, the engagement protuberance 112 may be integrally formed with the suction cup 110.

In at least one embodiment, at least a portion of the engagement protuberance 112, such as the mounting base 116, includes a locking member (such as a locking ring), as described herein. For example, the securing assembly 108 includes the engagement protuberance 112 that includes the locking member. The locking member is coupled to the suction cup 110. A suction securing nut is coupled to the suction cup 110 and the locking member. In at least one other embodiment, the mounting base 116 does not include a locking member.

A rim 132 may outwardly extend from the wall 126 below the cuff 124. A nut chamber 134 is defined between the cuff 124, the wall 126, and the rim 132. The suction securing nut 118 is configured to secure to the stem 130 of the suction cup 110 within the nut chamber 134.

The cuff 124 includes an arch 136 that outwardly extends from the wall 126, such as above the nut chamber 134. The arch 136 extends along a radial angle. For example, the arch 136 may extend along a radial angle of 180 degrees. The radial angle may be greater or less than 180 degrees. For example, the radial angle may be between 90 degrees and 270 degrees. As another example, the arch 136 may extend entirely around the nut chamber 134, thereby providing a fully circumferential tubular member.

The cuff 124 further includes a fin 138 that upwardly extends from a distal edge 140 of the arch 136. The distal edge 140 is distally located from the wall 126. The fin 138 includes lateral edges 142 and 144 connected by a main body 146 that includes a lower portion 148 connected to an upper portion 150. In at least one embodiment, the main body 146 extends further outwardly at the upper portion 150 than the lower portion 148. The main body 146 may gradually extend further with increased distance from the lower portion 148 toward the upper portion 150. As such, the main body 146 may form a semi-funnel shape. An upper edge 152 of the cuff 124 may be arcuate, such that recessed lateral portions 154 and 156 are lower than a middle portion 158. A smooth, curved edge is defined between the recessed lateral portions 154, 156 and the middle portion 158.

It has been found that the shape of the cuff 124 is ergonomically well suited to receive a forearm, wrist, or elbow of an individual between the arch 136 and the fin 138. The curved, arcuate surfaces of the arch 136 and the fin 138 are ergonomically configured to receive a forearm, wrist, or elbow of an individual.

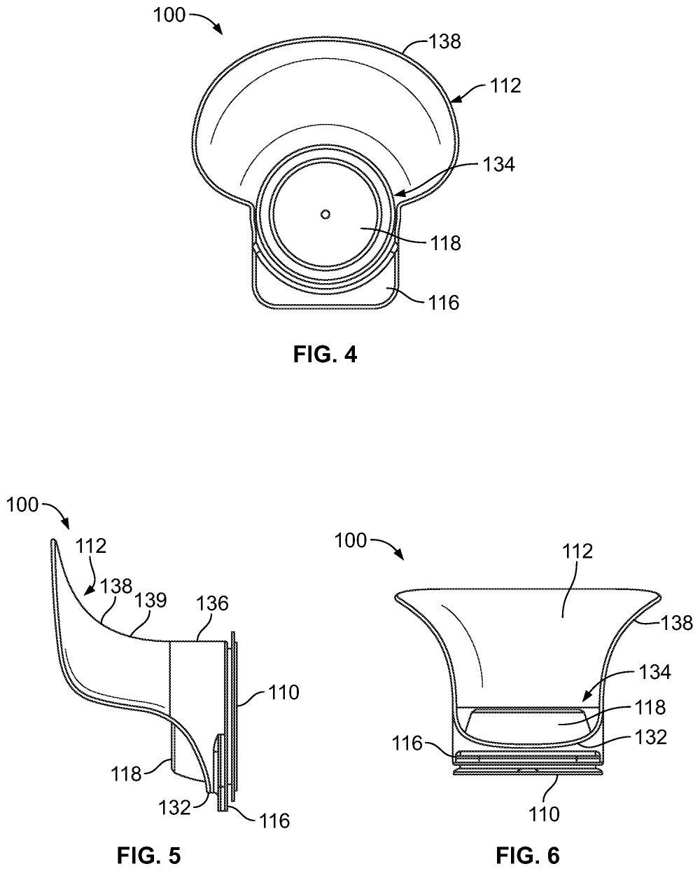

FIG. 4 illustrates a front view of the door opening system 100 of FIG. 3. The suction securing nut 118 secures to the suction cup 110 (shown in FIG. 3) within the nut chamber 134.

FIG. 5 illustrates a lateral view of the door opening system 100 of FIG. 3. As shown, the fin 138 may upwardly and outwardly curve from the arch 136. The fin 138 includes an arcuate rear surface 139 that is configured to be engaged by a forearm, wrist, or elbow of an individual.

FIG. 6 illustrates a bottom view of the door opening system 100 of FIG. 3. The fin 138 forms an arcuate canopy over the suction securing nut 118. The rim 132 may be inwardly recessed toward the suction cup 110.

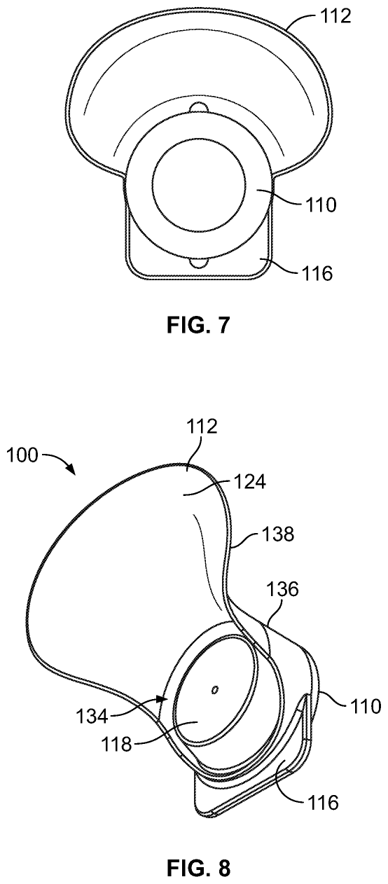

FIG. 7 illustrates a rear view of the door opening system 100 of FIG. 3. The suction cup 110 is configured to secure to a surface of a door of a structure.

FIG. 8 illustrates a perspective bottom view of the door opening system 100 of FIG. 3. The cuff 124 extends over and around at least a portion of an outer circumferential perimeter of the suction securing nut 118. For example, the cuff 124 may extend over and around at least an upper 135 degree radial circumferential portion of the suction securing nut 118. Optionally, the cuff 124 may extend over more or less than an upper 135 degree radial circumferential portion of the suction securing nut 118. In at least one embodiment, the cuff 124 may extend around an entire circumference of the suction securing nut 118.

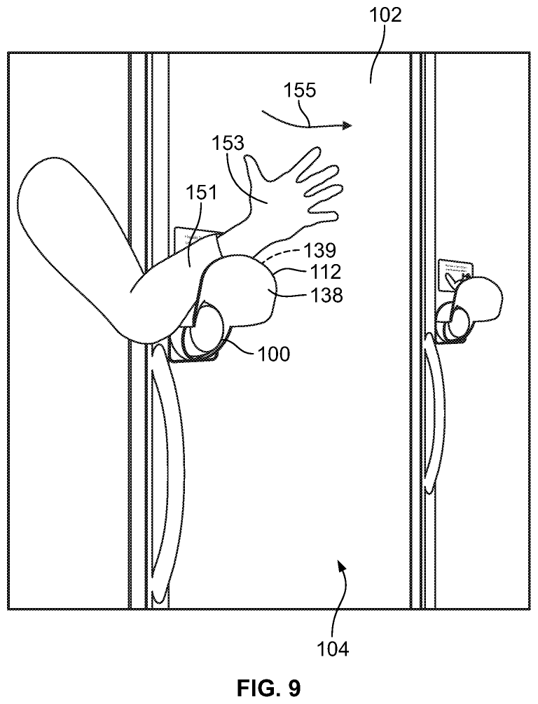

FIG. 9 illustrates a perspective view of a forearm 151 engaging the cuff 124 of the door opening system 100, according to an embodiment of the present disclosure. Referring to FIGS. 1-9, the forearm 151 is positioned on and/or over the arch 136 and abuts against the rear surface 139 of the fin 138. In order to open the door 102 without the use of a hand 153, the forearm is urged in the direction of arc 155 against the rear surface 139 of the fin 138 with sufficient force to pivot the door 102 open. Because the door opening system 100 is secured to the door 102 by the suction cup 110, the force exerted into the fin 138 by the forearm 151 pivots the door 102 open about one or more hinges, axles, or the like.

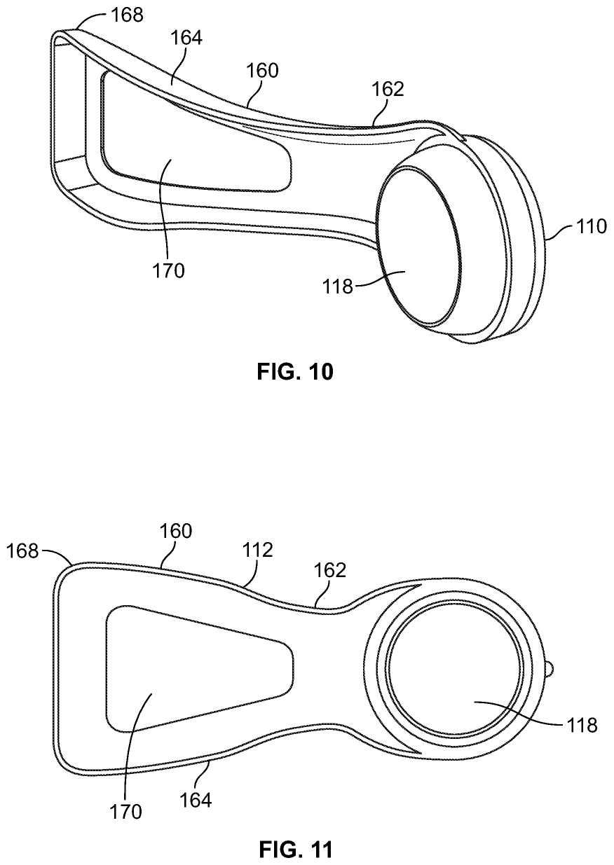

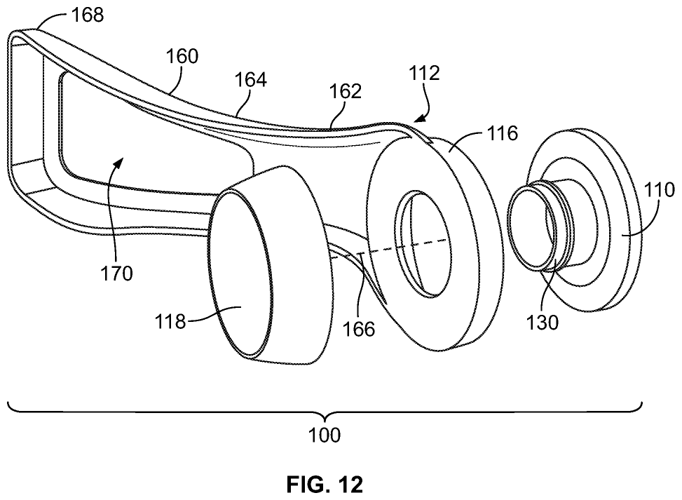

FIG. 10 illustrates a perspective lateral view of a door opening system 100, according to an embodiment of the present disclosure. FIG. 11 illustrates a front view of the door opening system 100 of FIG. 10. FIG. 12 illustrates a perspective exploded view of the door opening system 100 of FIG. 10. Referring to FIGS. 10-12, the engagement protuberance 112 includes a hook 160 extending from a mounting base 116. In at least one embodiment, the mounting base 116 includes a locking member, as described herein.

The hook 160 includes a root 162 outwardly extending from the mounting base 116. The root 162 connects to a beam 164 that curves outwardly away from a central longitudinal axis 166 of the mounting base 116. The beam 164 connects to a distal end 168. An opening 170 may be formed through the hook 160.

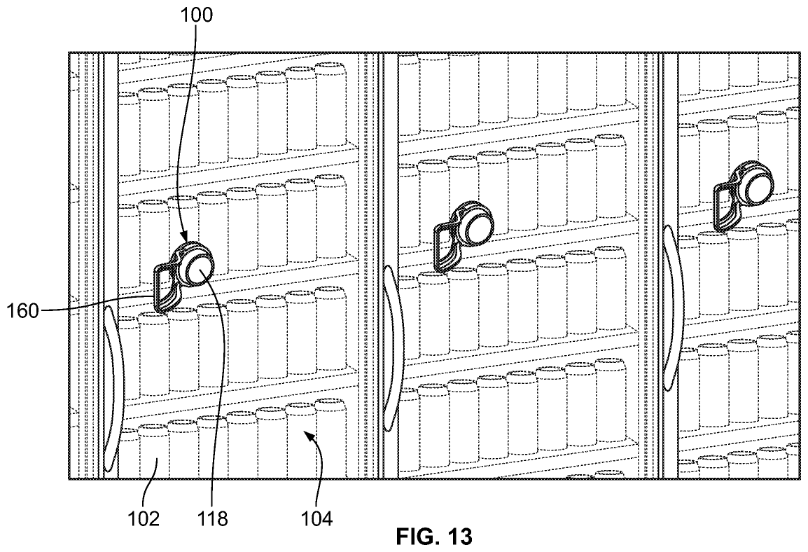

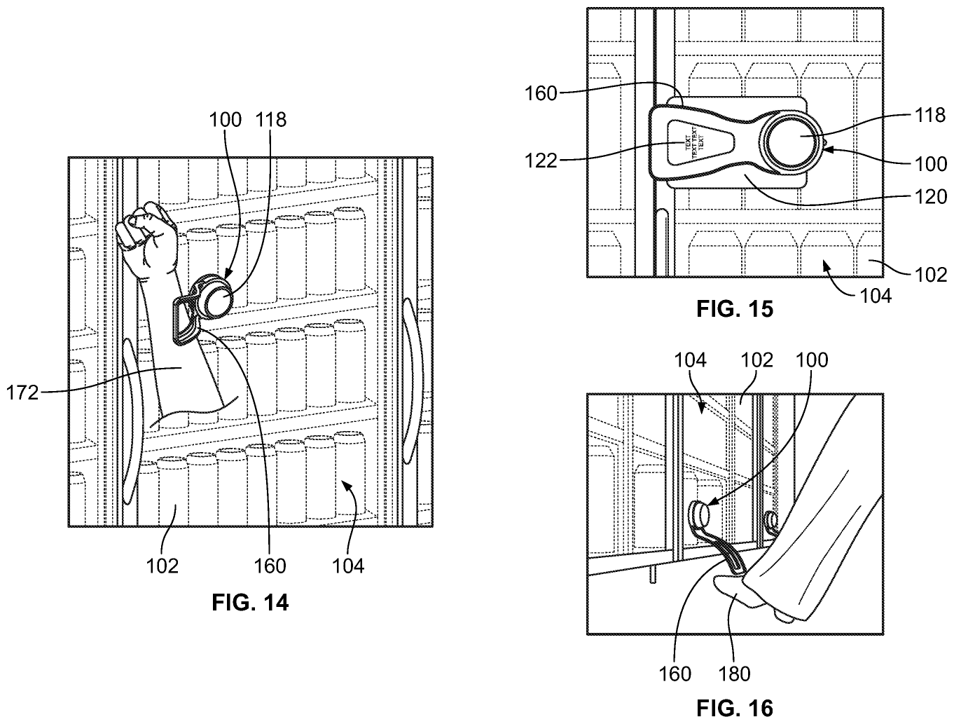

FIG. 13 illustrates a perspective front view of the door opening system 100 of FIG. 10 secured to the door 102 of the structure 104, according to an embodiment of the present disclosure. FIG. 14 illustrates a perspective view of a forearm 172 engaging the hook 160 of the door opening system 100. Referring to FIGS. 10-14, the door opening system 100 may be secured to the door 102 by the suction cup 110 such that the hook 160 laterally extends away from the suction securing nut 118. An individual may position a forearm, wrist, or elbow between the door 102 and the hook 160 and urge the forearm or elbow against the hook 160 to open the door 102 in a hands-free manner.

Referring to FIGS. 10-14, the hook 160 is ergonomically shaped to allow for engagement by a forearm, elbow, or wrist. The hook 160 may be optionally positioned to either side of the suction securing nut 118 depending on the opening direction of the door 102.

An individual may easily slide a wrist, forearm, or elbow between the hook 160 and the door 102 to pull open the door without the use of a hand. Further, a grasping device (such as a strap, claw, hooking utensil, or the like) may be inserted by an individual into the opening 170 and hook onto a rear portion of the hook 160 to open the door 102 without positioning a forearm, wrist, or elbow behind the hook 160.

FIG. 15 illustrates a front view of the door opening system 100 of FIG. 10 secured to the door 102 of the structure 104. The door opening system 100 may also include the decal 120 that is configured to be secured to the door 102, such as through an adhesive. Referring to FIGS. 10-15, the suction cup 110 may be secured to the door 102 with at least a portion of the decal 120 therebetween.

FIG. 16 illustrates a perspective view of a foot 180 engaging the hook 160 of the door opening system 100, according to an embodiment of the present disclosure. Optionally, the door opening system 100 may be secured to a lower portion of the door 102 via the suction cup 110 (shown in FIGS. 10 and 12). The hook 160 may be downwardly oriented (or optionally laterally oriented). In this manner, an individual may use the foot 180 against a rear surface of the hook 160 to open the door 102.

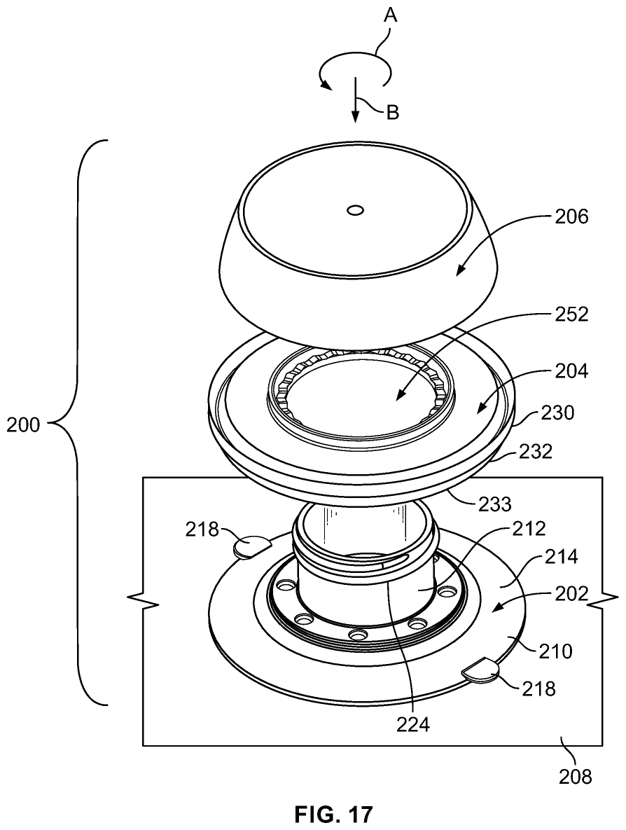

FIG. 17 illustrates a perspective exploded view of a securing assembly 200, according to an embodiment of the present disclosure. The securing assembly 108 shown in FIG. 1 may include components of the securing assembly 200. For example, in at least one embodiment, the engagement protuberance 112 shown and described with respect to FIGS. 1-16 may include a locking member (such as a locking ring 204), as described herein.

The securing assembly 200 includes a suction cup 202 (such as the suction cup 110 shown in FIG. 1), a locking member, such as a locking ring 204 (such as may be part of the engagement protuberance 112 shown in FIG. 1), and a suction securing nut 206 (such as the suction securing nut 118 shown in FIG. 2). The suction cup 202 is configured to directly couple to a structure 208 (for example, the door 102 of the structure 104 shown in FIG. 1). The locking ring 204 couples to the suction cup 202. The suction securing nut 206 couples to the locking ring 204 and the suction cup 202. Optionally, the locking member may be a non-ring like structure, such as one or more panels, or the like.

As shown, the locking ring 204 is disposed between the suction cup 202 and the suction securing nut 206. A portion of the locking ring 204 (such as a beveled rim 232) is configured to be urged into a portion of the suction securing nut 206 (such as an annular lip 214 of a suctioning base 210 as the suction securing nut 206 is tightened in relation to the suction cup 202. In at least one embodiment, an intermediate structure, such as a portion of a bracket or the like, may be disposed between the suction securing nut 206 and the locking ring 204, and/or the locking ring 204 and the suction cup 202.

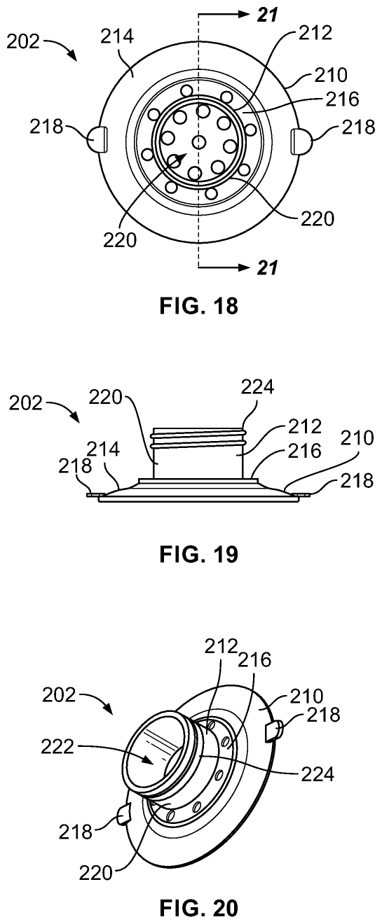

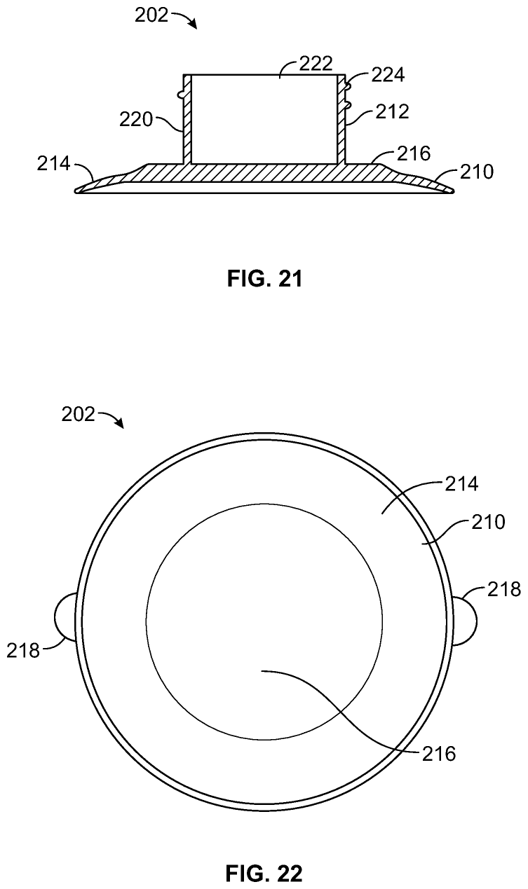

FIG. 18 illustrates a top view of the suction cup 202, according to an embodiment of the present disclosure. FIG. 19 illustrates a lateral view of the suction cup 202. FIG. 20 illustrates a perspective top view of the suction cup 202. FIG. 21 illustrates a cross-sectional view of the suction cup 202 through line 21-21 of FIG. 18. FIG. 22 illustrates a bottom view of the suction cup 202.

Referring to FIGS. 18-22, the suction cup 202 includes a suctioning base 210 integrally connected to a stem 212 (such as the stem 130 shown in FIG. 3) extending upwardly from the suctioning base 210. The suctioning base 210 may include an outer annular lip 214 surrounding a flattened interior circular body 216. Pull tabs 218 may extend radially outward from outer edges of the annular lip 214. The pull tabs 218 are configured to be pulled outwardly from a surface to remove the suction cup 202 therefrom.

The stem 212 includes a cylindrical shaft 220 surrounding a central channel 222 that extends to the suctioning base 210. An outer surface of the shaft 220 may include threads 224 that are configured to threadably engage interior threads of the suction securing nut 206 (shown in FIG. 17).

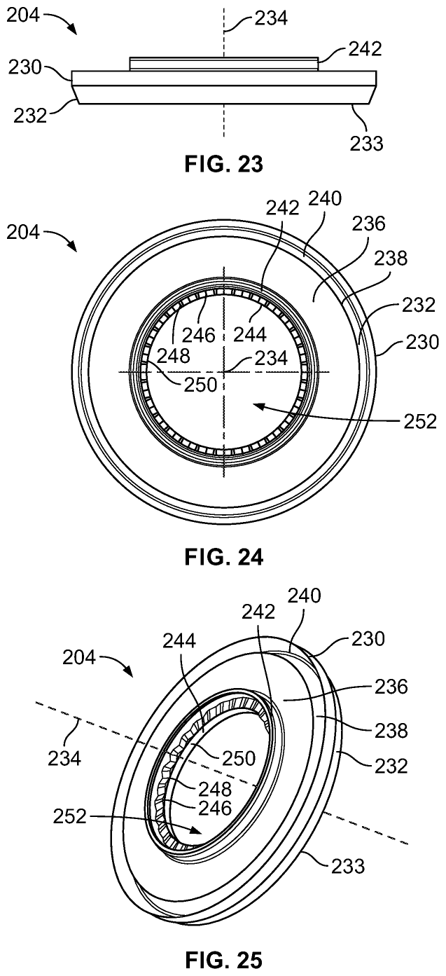

FIG. 23 illustrates a lateral view of the locking ring 204, according to an embodiment of the present disclosure. FIG. 24 illustrates a top view of the locking ring 204. FIG. 25 illustrates a perspective top lateral view of the locking ring 204.

Referring to FIGS. 23-25, the locking ring 204 includes an annular outer rim 230 and a beveled rim 232 extending downwardly from the outer rim 230. The beveled rim 232 inwardly cants from the outer rim 230 towards a central axis 234 of the locking ring 204. The inward cant angle of the beveled rim 232 may be greater or less than shown.

An inboard support base 236 connects to an inner diameter of the beveled rim 232 through an interior rim 238. The interior rim 238 may be coaxial with the outer rim 230. An interior groove 240 is formed between the outer rim 230, the beveled rim 232, and the interior rim 238.

An interior diameter of the inboard support base 236 connects to an interior upstanding annular wall 242, which upwardly extends from the support base 236. An interior ledge 244 inwardly extends from the annular wall 242 towards and about the central axis 234. The interior ledge 244 may be within one or more planes that are parallel to a plane of an upper surface of the support base 236. The interior ledge 244 may be serrated, and include a plurality of alternating peaks or teeth 246 and valleys or recesses 248 extending therearound. An interior edge 250 defines an internal circular passage 252. Alternatively, the interior ledge 244 may be smooth and flat, instead of serrated.

Referring to FIGS. 17-25, the locking ring 204 fits over the suction cup 202, such that the stem 212 passes through the passage 252 of the locking ring 204. A bottom edge 233 of the beveled rim 232 abuts into an upper surface of the annular lip 214 of the suctioning base 210.

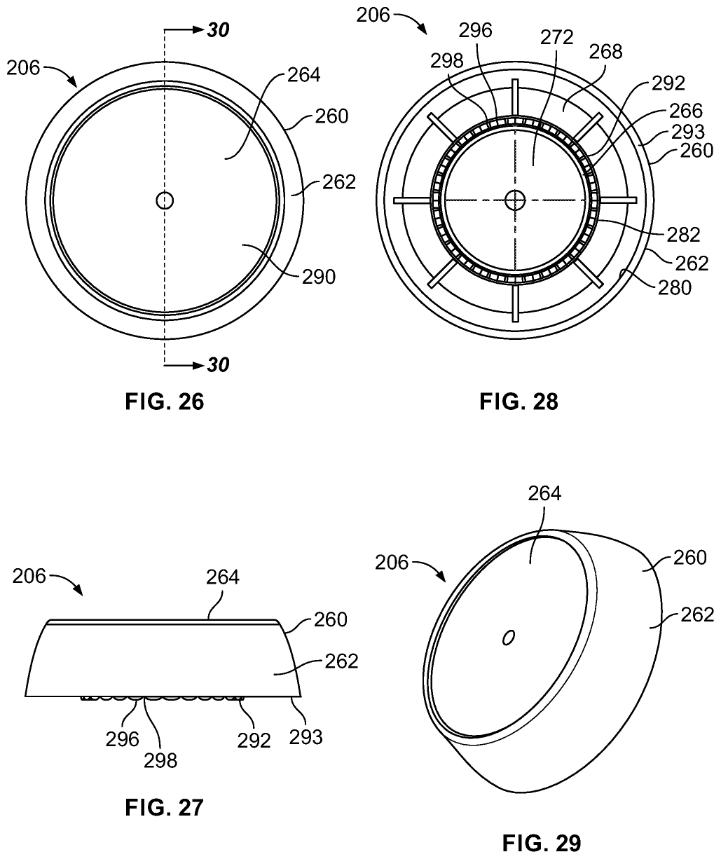

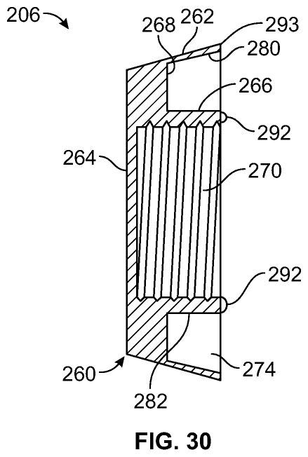

FIG. 26 illustrates a top view of the suction securing nut 206, according to an embodiment of the present disclosure. FIG. 27 illustrates a lateral view of the suction securing nut 206. FIG. 28 illustrates a bottom view of the suction securing nut 206. FIG. 29 illustrates a perspective top view of the suction securing nut 206. FIG. 30 illustrates a cross-sectional view of the suction securing nut 206 through line 30-30 of FIG. 26.

Referring to FIGS. 26-30, the suction securing nut 206 includes an outer shroud 260 having an outer circumferential wall 262 connected to an outer cap 264. An interior connecting tube 266 extends inwardly from an interior surface 268 of the cap 264. The connecting tube 266 includes an interior threaded surface 270 surrounding a central chamber 272. An outer channel 274 is defined between an interior surface 280 of the wall 262 and an outer surface 282 of the connecting tube 266. Alternatively, the stem 212 of the suction cup 202 may include an interior threaded surface that threadably receives and engages an outer threaded surface of the connecting tube 266 of the suction securing nut 206.

An outer surface 290 of the cap 264 may be configured to support one or more graphics, such as advertisements, information, or the like. For example, a graphics display may be formed on the outer surface 290 of the cap 264. In at least one embodiment, graphics displays may be directly formed, etched, written, adhesively secured, and/or the like onto the outer surface 290 of the cap 264. In at least one other embodiment, a clear pocket may be formed over the outer surface 290, and the graphics display may be formed on a sheet of plastic, paper, or the like that is inserted between the outer surface 290 and an interior surface of the clear pocket.

As shown, a lower edge 292 of the interior connecting tube 266 may extend below a lower surface 293 of the outer circumferential wall 262. The lower surface 293 may be serrated and include a plurality of alternating peaks or teeth 296 and valleys or recesses 298 extending therearound. The lower surface 293 of the interior connecting tube 266 is configured to couple to the interior ledge 244 of the locking ring 204 (shown in FIGS. 23-25), such that the peaks 296 and valleys 298 of the connecting tube 266 engage the peaks 246 and valleys 248 of the interior ledge 244 of the locking ring 204, thereby forcing the locking ring 204 into the suction cup 202. Alternatively, the lower surface 293 may be smooth and flat, instead of serrated.

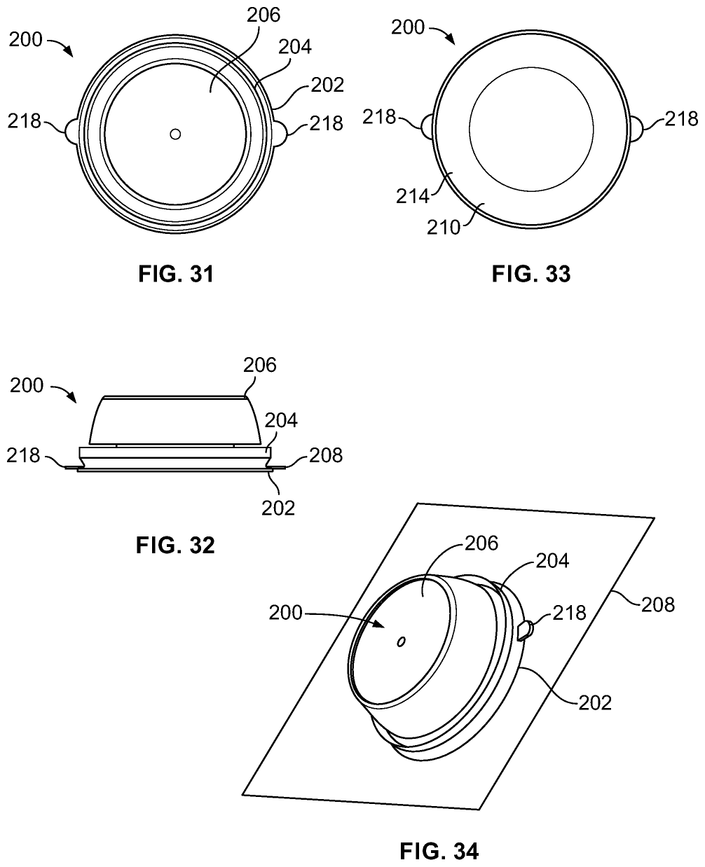

FIG. 31 illustrates a top view of the securing assembly 200. FIG. 32 illustrates a lateral view of the securing assembly 200. FIG. 33 illustrates a bottom view of the securing assembly 200. FIG. 34 illustrates a perspective view of the securing assembly 200 secured to the structure 208.

Referring to FIGS. 17-34, after the locking ring 204 has been coupled to the suction cup 202, as described above, the suction securing nut 206 is axially aligned over the stem 212 of the suction cup 202. The suction securing nut 206 is then urged onto the suction cup 202 such that the interior threaded surface 270 of the connecting tube 266 threadably engages the threads 224 of the stem 212. The suction securing nut 206 is then rotated in a securing direction A relative to the suction cup 202. As the suction securing nut 206 continues to be threaded in the securing direction A, the lower ledge 292 of the interior connecting tube 266 is forced into the interior ledge 244 of the locking ring 204, thereby forcing the locking ring downwardly towards the suction cup 202 in the direction of arrow B. The engagement of the alternating peaks and valleys of the lower ledge 292 and the interior ledge 244 may axially secure the suction securing nut 206 with respect to the locking ring 204 (such as via the peaks 296 of the lower ledge 292 mating into reciprocal valleys 248 of the interior ledge 244, and the peaks 246 of the interior ledge 244 mating into reciprocal valleys 298 of the lower ledge 292), so as to reduce slippage therebetween. As the suction securing nut 206 is tightened with respect to the stem 212, the bottom edge 233 of the beveled rim 232 of the locking ring 204 is forced into the annular lip 214 of the suctioning base 210, which causes the annular lip 214 to flatten. The flattening of the annular lip 214 provides a vacuum between the structure 208 and the suction cup 202. The locking ring 204 locks the suction cup 202 to the structure 208 via engagement with the suction securing nut 206. The suction securing nut 206 forces the locking ring 204 into the annular lip 214, flattening the annular lip 214 and forming a vacuum between the suction cup 202 and the structure 208, which forms a robust, strong, and reliable connection therebetween.

In order to remove the securing assembly 200 from the structure 208, the suction securing nut 206 is rotated in a direction that is opposite to the securing direction A (optionally, the securing direction A and the opposite direction may be reversed). As the suction securing nut 206 disengages from the stem 212 of the suction cup 202, the suction securing nut 206 disengages from the locking ring 204. As such, the force exerted by the locking ring 204 into the annular lip 214 decreases. The pull tabs 218 may then be pulled away from the structure 208, thereby removing the suction cup 202 therefrom.

As described herein, the suction cup 202, the locking ring 204, and the suction securing nut 206 may form the securing assembly 200. As the connecting tube 266 is rotated into a securing position with the stem 212, the locking ring 204 is forced into the annular lip 214 of the suctioning base 210, which greatly increases the suctioning force exerted by the suctioning base 210 (such as by drawing air out of the interface between the structure 208 and the suctioning base 210 to create a vacuum), thereby increasing the securing force between the securing assembly 200 and the surface of the structure 208. It has been found that by including the locking ring 204 in the securing assembly 200, increased suction retaining force is achieved with the surface of the component, such as a glass surface of a refrigerated compartment door. The resulting suctioning force achieved by operation of the locking ring 204 with the suction securing nut 206 and the suction cup 202 greatly exceeds that of a standard suction cup that is merely linearly pressed into a surface of a component.

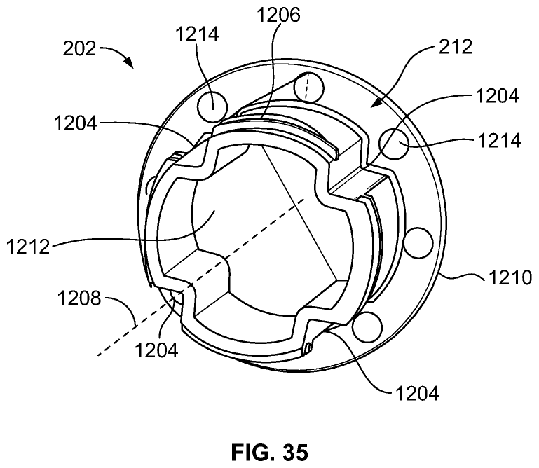

FIG. 35 illustrates a perspective top view of a stem 212 of a suction cup 202, according to an embodiment of the present disclosure. Keying members 1204 may be formed through the stem 212. Outer surfaces of the stem 212 may include threads 1206, as described above. The keying members 1204 may be channels, indentations, divots, recessed areas, notches, slots, or the like, formed in an outer surface of the stem 212. Each keying member 1204 may be formed along a height of the stem 212 and may be parallel to a central axis 1208 of the stem 212. As shown, four evenly-spaced keying members 1204 are shown. Alternatively, more or less keying members than shown may be used.

The keying members 1204 provide alignment keys that are configured to receive reciprocal structures formed on a component, such as an engagement protuberance, an accessory, bracket or the like, in order to maintain the component in a desired position. For example, securing mounts may include inwardly directed tabs extending into the passages. The tabs may be retained within the keying members 1204 to securely maintain the engagement protuberance 112 (shown in FIG. 1, for example) at a desired orientation. Any of the embodiments described herein may include the keying members 1204. Optionally, embodiments may not include the keying members 1204.

Additionally, a flange 1210 radially extends from a base 1212 of the stem 212. The flange 1210 may include one or more holes 1214 formed therethrough. More or less holes than shown may be used. A suctioning base (such as the suctioning base 210) may be secured over or otherwise onto the flange 1210. The holes 1214 are configured to allow the flexible material of the suctioning base to flow around and through the flange 1210, thereby providing an increased retaining interface, as well as providing a greater degree of flexibility to the suctioning base. Any of the embodiments described herein may include the holes 1214. Optionally, embodiments may not include the holes 1214.

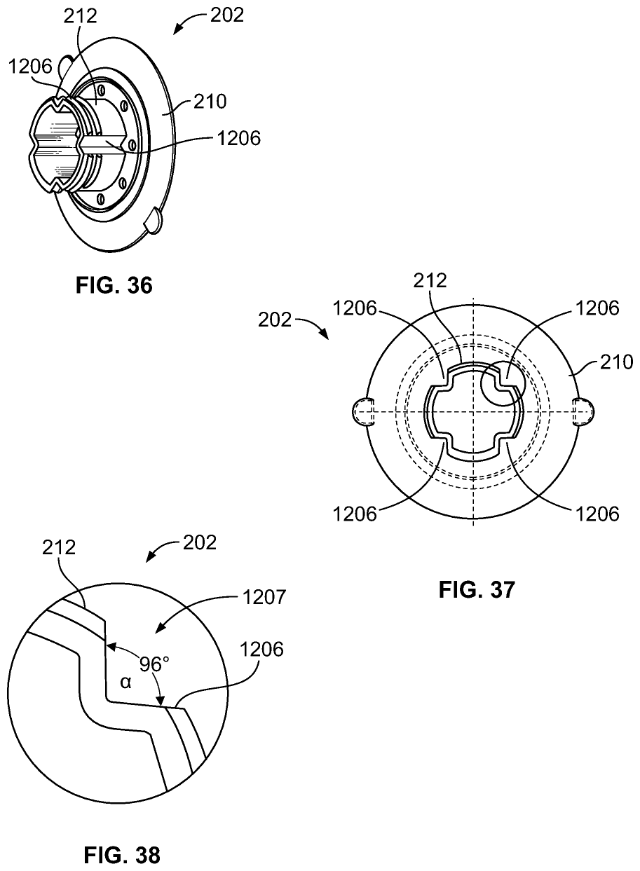

FIG. 36 illustrates a perspective view of the suction cup 202, according to an embodiment of the present disclosure. FIG. 37 illustrates a top view of the suction cup 202. Referring to FIGS. 36 and 37, as shown, the suctioning base 210 is secured to the stem 212. The threads 1206 are formed on an outer surface of the stem 212, while the keying members 1204 are formed through portions of the stem 212.

FIG. 38 illustrates a top view of a keying member 1206 of the suction cup 202, according to an embodiment of the present disclosure. As shown, the keying member 1206 may be an indented feature within the outer wall of the stem 212. The indentation 1207 may form an angle α that may conform to an outer surface of a mounting bracket of a component. For example, the angle α may be 96 degrees. Alternatively, the angle α may be greater or less than 96 degrees.

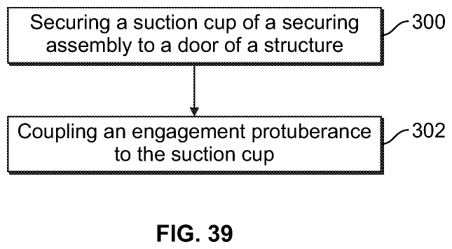

FIG. 39 illustrates a flow chart of a hands-free door opening method, according to an embodiment of the present disclosure. The door opening method includes securing, at 300, a suction cup of a securing assembly to a door of a structure; and coupling, at 302, an engagement protuberance to the suction cup. The engagement protuberance is configured to be engaged in a hands-free manner to open the door. In at least one embodiment, the engagement protuberance is distinct from a handle of the door.

In at least one embodiment, the door opening method also includes securing at least a portion of the engagement protuberance between the suction cup and a suction securing nut. Further, the method may include coupling a locking member of the engagement protuberance to the suction cup and the suction securing nut.

In at least one example, the door opening method may also include securing a decal to the door. The decal includes indicia that indicate instructions for opening the door, via the engagement protuberance, in the hands-free manner.

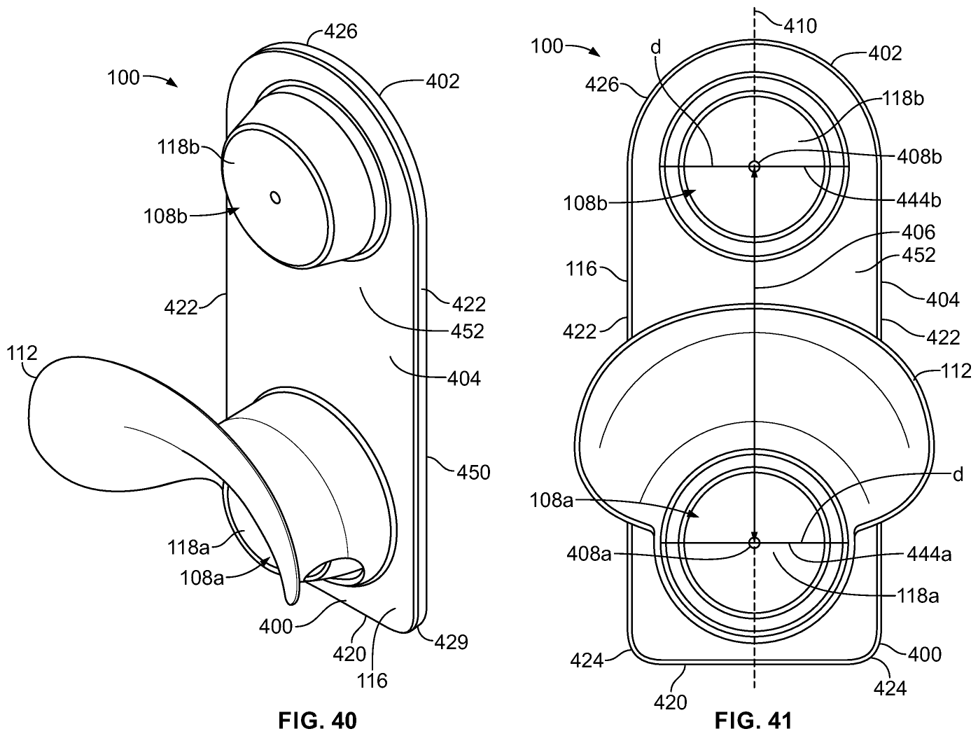

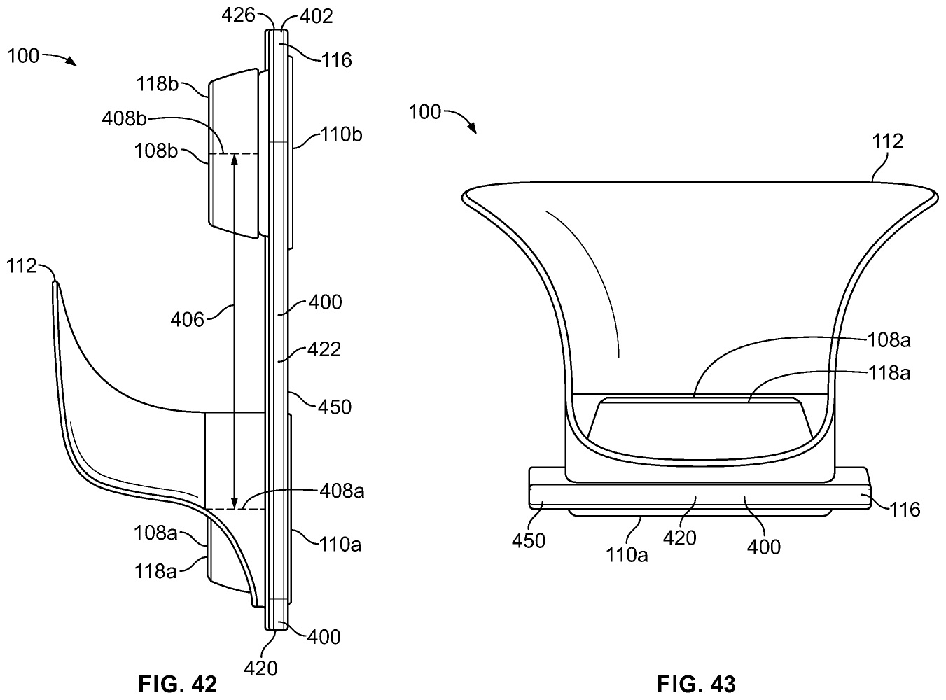

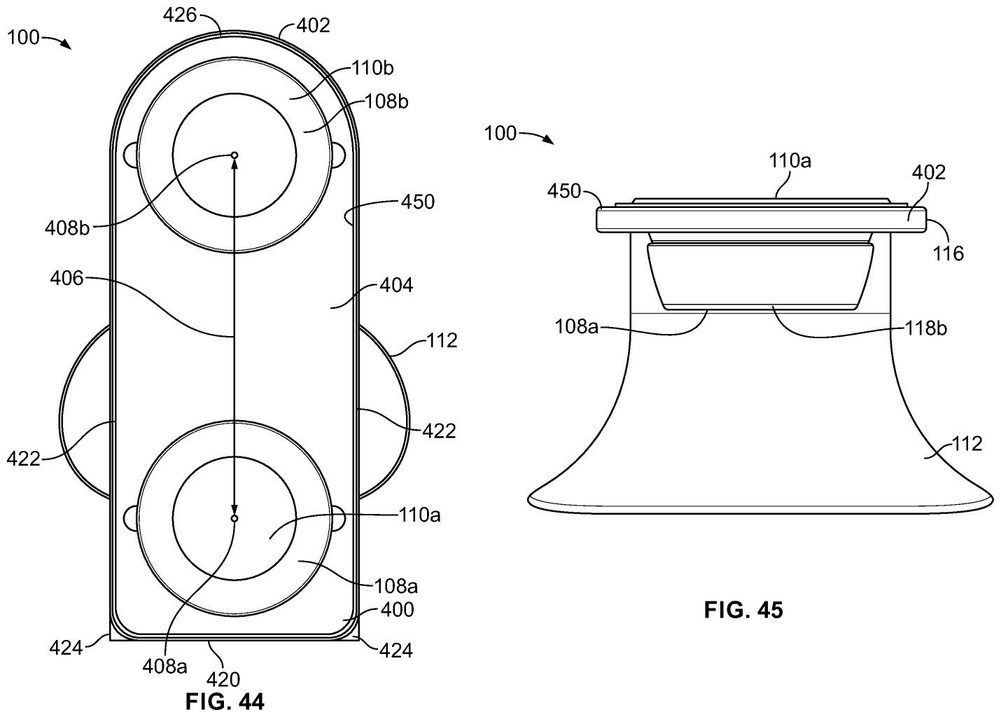

FIG. 40 illustrates a perspective front view of a door opening system 100, according to an embodiment of the present disclosure. FIG. 41 illustrates a front view of the door opening system 100 of FIG. 40. FIG. 42 illustrates a lateral view of the door opening system 100 of FIG. 40. FIG. 43 illustrates a bottom view of the door opening system 100 of FIG. 40. FIG. 44 illustrates a rear view of the door opening system 100 of FIG. 40. FIG. 45 illustrates a top view of the door opening system 100 of FIG. 40.

Referring to FIGS. 40-45, the door opening system 100 includes a first (or lower) securing assembly 108a including a first (or lower) suction cup 110a coupled to an engagement protuberance 112 and a first (or lower) suction securing nut 118a. A mounting base 116 includes first (or lower) end 400 connected to a second (or upper) end 402 by an intermediate extension 404. A second (or upper) securing assembly 108b including a suction cup 110b is coupled to a second (or upper) suction securing nut 118b. At least a portion of the first end 400 of the mounting base 116 is configured to be secured between the suction cup 110a and the first suction securing nut 118a. Similarly, at least a portion of the second end 402 of the mounting base 116 is configured to be secured between the suction cup 110b and the second suction securing nut 118b.

In at least one embodiment, the engagement protuberance 112 is configured as shown and described with respect to FIGS. 1-9. Alternatively, the engagement protuberance 112 can be configured as shown and described with respect to FIGS. 10-16.

The intermediate extension 404 separates the first securing assembly 108a from the second securing assembly 108b. For example, a straight line distance 406 between a center 408a of the first securing assembly 108a and a center 408b of the second securing assembly 108b can be at least twice a diameter d of the first securing assembly 108a (or the second securing assembly 108b), such as includes an outer surface of the first suction securing nut 118a (or the second suction securing nut 118b). As such, the second securing assembly 108b is spaced a sufficient distance from the engagement protuberance 112 so as not the interfere with an individual engaging the engagement protuberance 112 during operation, as described herein. Optionally, the distance 406 can be greater than twice the diameter d, or less than the twice the diameter d.

As shown, the first securing assembly 108a is longitudinally aligned with the second securing assembly 108b along a longitudinal axis 410 of the mounting base 116. Alignment of the first securing assembly 108a and the second securing assembly 108b along the longitudinal axis 410 ensures consistent and robust securement to a structure, particularly when an individual engages the engagement protuberance 112.

Further, the multiple securing assemblies 108a and 108b provide increased retaining capability and strength in relation to the structure. It has been found that the addition of the second securing assembly 108b above the first second securing assembly 108a ensures that the door opening system 100 remains reliably and consistently secured to the structure even when an individual engages the engagement protuberance with more force than needed to open a door with the door opening system 100.

As shown, the first end 400 of the mounting base 116 includes a linear bottom 420 connected to linear side walls 422 that extend into and through the intermediate extension 404. The linear bottom 420 can be perpendicular to the linear side walls 422. Rounded contours 424 smoothly transition between the bottom 420 and the side walls 422, thereby reducing a possibility of snagging on clothing, bags, backpacks, or the like. Upper portions of the linear side walls 422 connect to a rounded, semicircular top 426 of the second end 402. Again, the smooth, rounded, contour of the top 426 reduces a possibility of snagging on clothing, bags, backpacks, or the like.

The outer perimeter of the mounting base 116 can be sized and shaped differently than shown. For example, the top 426 can be optionally linear, instead of semicircular. Additionally, the side walls 422 can be angled, curved, or the like. In at least one embodiment, additional extensions can laterally extend from the side walls 422 and be configured to retain additional securing assemblies.

As shown in FIGS. 40-45, the door opening system 100 includes the engagement protuberance 112 extending from the mounting base 116. The mounting base 116 retains the first securing assembly 108a and the second securing assembly 108b, which cooperate to secure the door opening system to a surface of a structure, such as a glass door of a refrigerated compartment.

The mounting base 116 provides an extended panel that surrounds outer perimeters or axial envelopes 444a and 44b of the first securing assembly 108a and the second securing assembly 108b, respectively. A rearwardly-directed lip 450 extends from the mounting base 116. That is, in at least one embodiment, the mounting base 116 includes the lip 450, which extends around a perimeter of the mounting base 116, and rearwardly extends away from a front face 452 of the mounting base 116. Optionally, the lip 450 may extend around less than an entire perimeter of the mounting base 116.

The lip 450 extends from the mounting base 116 in an opposite direction from the engagement protuberance 112 (which extends in a forward direction). The lip 450 is configured to abut against the surface of the structure (such as a glass door of a refrigerated compartment) to securely anchor the door opening system 100 to the surface when the securing assemblies 108a and 108b secure the door opening system 100 to the surface. The lip 450 abutting the surface provides stability, and eliminates, minimizes, or otherwise reduces the potential of portions of the suction cups 110a and 110b from twisting when an individual pulls on the cuff 124 (such as when using the door opening system 100 to open a door). The multiple securing assemblies 108a and 108b and the lip 450, which provides anchoring stability, ensures that the suction cups 110a and 110b securely engage the structure without being twisted or loosening grip.

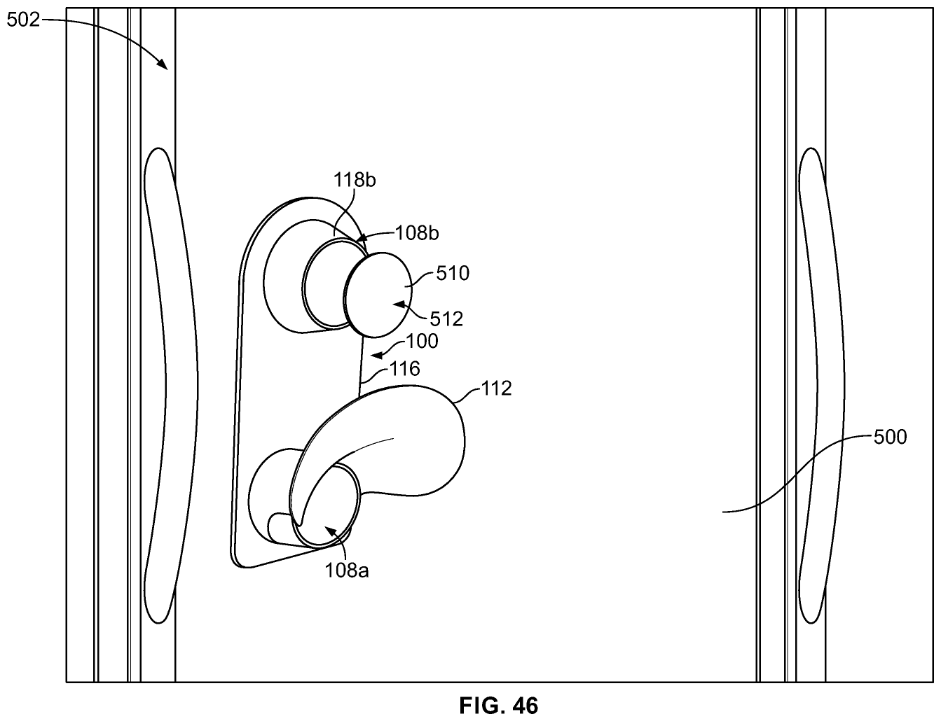

FIG. 46 illustrates a perspective front view of the door opening system 100 secured to a door 500 of a structure 502, according to an embodiment of the present disclosure. For example, the structure 502 can be a refrigerated compartment, and the door 500 can be a glass door. The door opening system 100 secures to the door 500 via the first securing assembly 108a and the second securing assembly 108b, as described above.

As shown, a decal 510 can be applied to a portion of the door opening system 100. For example, the decal 510 can be adhesively secured to an outer surface of the suction securing nut 118b. The decal 510 can include instructions 512 for operating the door opening system 100 to open the door 500.

Referring to FIGS. 40-46, in at least one embodiment, the door opening system 100 includes the mounting base 116, the engagement protuberance 112 extending from the mounting base 116, the first securing assembly 108a having the first suction cup 110a coupled to the mounting base 116, and the second securing assembly 108b having the second suction cup 110b coupled to the mounting base 116. The first suction cup 110a and the second suction cup 110b are configured to secure the door opening system 100 to the door 500 of the structure 502. The engagement protuberance 112 is configured to be engaged in a hands-free manner to open the door 500.

As described herein, embodiments of the present disclosure provide systems and methods for opening a door of a structure that reduce a risk of spreading pathogens to individuals. Further, embodiments of the present disclosure provide hands-free systems and methods for opening a door of a structure. Moreover, embodiments of the present disclosure provide robust securing assemblies that include a suction cup. Embodiments of the present disclosure provide securing assemblies that provide a strong and reliable connection with a surface of a structure.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A door opening system comprising:
a mounting base;
an engagement protuberance extending from the mounting base;
a first securing assembly having a first suction cup coupled to the mounting base; and
a second securing assembly having a second suction cup coupled to the mounting base,
wherein the first suction cup and the second suction cup are configured to secure the door opening system to a door of a structure, and
wherein the engagement protuberance is configured to be engaged in a hands-free manner to open the door.

2. The door opening system of claim 1, wherein the first securing assembly further comprises a first suction securing nut coupled to the first suction cup, wherein at least a portion of the engagement protuberance is secured between the first suction cup and the first suction securing nut, and wherein the second securing assembly further comprises a second suction securing nut coupled to the second suction cup.

3. The door opening system of claim 1, wherein the mounting base comprises a first end connected to a second end by an intermediate extension, wherein the first securing assembly is coupled to the first end, and wherein the second securing assembly is coupled to the second end.

4. The door opening system of claim 1, wherein the first securing assembly is separated from the second securing assembly a distance that is at least twice a diameter of one or both of the first securing assembly or the second securing assembly.

5. The door opening system of claim 1, wherein the first securing assembly is longitudinally aligned with the second securing assembly along a longitudinal axis of the mounting base.

6. The door opening system of claim 1, wherein the mounting base comprises a lip that is configured to abut against the door of the structure.

7. The door opening system of claim 6, wherein the lip extends around at least a portion of a perimeter of the mounting base.

8. The door opening system of claim 1, wherein the engagement protuberance is distinct from a handle of the door.

9. The door opening system of claim 1, further comprising a decal that is configured to be secured to a portion of the door opening system, wherein the decal includes indicia that indicate instructions for opening the door, via the engagement protuberance, in the hands-free manner.

10. The door opening system of claim 1, wherein the engagement protuberance comprises:
a mounting base; and
a cuff extending outwardly from the mounting base away from the suction cup.

11. The door opening system of claim 10, wherein the mounting base comprises a wall that is configured to abut against the first suction cup, wherein a channel is formed through the wall, and wherein the channel is configured to receive a stem of the first suction cup that passes through the channel and is engaged by a first suction securing nut.

12. The door opening system of claim 10, wherein the cuff comprises:
an arch outwardly extending from a wall of the mounting base; and
a fin extending from the arch.

13. The door opening system of claim 12, wherein the fin comprises lateral edges connected by a main body that includes a lower portion connected to an upper portion.

14. The door opening system of claim 13, wherein the main body extends further outwardly at the upper portion than the lower portion.

15. The door opening system of claim 12, wherein the fin upwardly and outwardly curves from the arch.

16. A door opening method comprising:
coupling a first securing assembly having a first suction cup to a mounting base having an engagement protuberance extending therefrom;
coupling a second securing assembly having a second suction cup to the mounting base; and
securing, by the first suction cup and the second suction cup, the door opening system to a door of a structure,
wherein the engagement protuberance is configured to be engaged in a hands-free manner to open the door.

17. The door opening method of claim 16, further comprising abutting a lip of the mounting base against the door of the structure.

18. A door opening system comprising:
a mounting base comprises a first end connected to a second end by an intermediate extension, wherein the mounting base further comprises a lip that is configured to abut against a door of a structure;
an engagement protuberance extending from the mounting base, wherein the engagement protuberance is distinct from a handle of the door;
a first securing assembly coupled to the first end of the mounting base, wherein the first securing assembly comprises a first suction cup coupled to a first suction securing nut, wherein at least a portion of the engagement protuberance is secured between the first suction cup and the first suction securing nut; and
a second securing assembly coupled to the second end of the mounting base, wherein the second securing assembly comprises a second suction cup coupled to a second suction securing nut,
wherein the first securing assembly is longitudinally aligned with the second securing assembly along a longitudinal axis of the mounting base,
wherein the first securing assembly is separated from the second securing assembly a distance that is at least twice a diameter of one or both of the first securing assembly or the second securing assembly,
wherein the first suction cup and the second suction cup are configured to secure the door opening system to the door of the structure, and
wherein the engagement protuberance is configured to be engaged in a hands-free manner to open the door.

19. The door opening system of claim 18, wherein the engagement protuberance comprises:
a mounting base; and
a cuff extending outwardly from the mounting base away from the suction cup.

20. The door opening system of claim 19, wherein the mounting base comprises a wall that is configured to abut against the first suction cup, wherein a channel is formed through the wall, and wherein the channel is configured to receive a stem of the first suction cup that passes through the channel and is engaged by a first suction securing nut, wherein the cuff comprises:
an arch outwardly extending from a wall of the mounting base; and
a fin extending from the arch, wherein the fin comprises lateral edges connected by a main body that includes a lower portion connected to an upper portion, wherein the main body extends further outwardly at the upper portion than the lower portion, and wherein the fin upwardly and outwardly curves from the arch.
